(19) United States
(12) Patent Application Publication
(10) Pub. No.: US 2025/0381613 A1
(43) Pub. Date: Dec. 18, 2025

(54) LASER PROCESSING APPARATUS AND LASER PROCESSING METHOD

(71) Applicant: DISCO CORPORATION, Tokyo (JP)

(72) Inventor: Tsubasa HIROSE, Tokyo (JP)

(21) Appl. No.: 19/211,589

(22) Filed: May 19, 2025

(30) Foreign Application Priority Data
Jun. 13, 2024 (JP) 2024-095646

(51) Int. Cl. B23K 26/0622; B23K 26/06

(52) U.S. Cl. CPC B23K 26/0622; B23K 26/0665

(57) ABSTRACT

A laser beam processing apparatus, that allows to obtain a desired processing result for various workpieces without damaging a device during laser processing, is provided. The laser processing apparatus includes: a chuck table that holds a workpiece; a laser beam applying unit that applies a pulsed laser beam to the workpiece held on the chuck table; and a feeding unit that relatively feeds the chuck table and the laser beam applying unit for processing. The laser beam applying unit includes: an oscillator that oscillates a pulsed laser beam, and a condenser that collects the pulsed laser beam LB oscillated by the oscillator, and applies the pulsed laser beam to the workpiece held on the chuck table. A repetition frequency of the pulsed laser beam oscillated by the oscillator is set to at least a value determined by multiplying a thermal conductivity λ[W/(m·K)] of the workpiece by a coefficient β[MHz·m·K/W].

### BACKGROUND

### 1. Technical Field

The present disclosure relates to a laser processing apparatus including a chuck table that holds a workpiece, a laser beam applying unit that applies a pulsed laser beam to the workpiece held on the chuck table, and a feeding unit that relatively feeds the chuck table and the laser beam applying unit for processing, and a laser processing method for the workpiece.

### 2. Description of the Related Art

A wafer, where a plurality of devices such as ICs and LSIs are divided by a division line and formed on the front surface, is divided into individual device chips by a laser processing apparatus, and the divided device chips are used for electric appliances, such as portable telephones and personal computers.

The laser processing apparatus includes a chuck table that holds a workpiece, a laser beam applying unit that applies a pulsed laser beam to the workpiece held on the chuck table, and a feeding unit that relatively feeds the chuck table and the laser beam applying unit for processing, and can perform a desired processing on the wafer thereby (e.g. see Japanese Patent No. 6151557).

### SUMMARY

In a case where a wafer is formed of SiC, however, if a start point of division is formed by applying the pulsed laser beam along the division line, cracking may extend from the division line along a crystal structure, which damages the device.

Another problem is that a satisfactory processing result may not be obtained even if various adjustments are attempted, such as adjusting the output of the laser beam, adjusting the feeding speed, or adjusting the focusing point position.

It is an object of the present disclosure to provide a laser processing apparatus and a laser processing method that allow obtaining a desired processing result for various workpieces without damaging the device during laser processing.

According to the present disclosure, the following laser processing apparatus that solves the above problem is provided. That is, a laser processing apparatus including: a chuck table that holds a workpiece; a laser beam applying unit that applies a pulsed laser beam to the workpiece held on the chuck table; and a feeding unit that relatively feeds the chuck table and the laser beam applying unit for processing, is provided. The laser beam applying unit includes: an oscillator that oscillates a pulsed laser beam; and a condenser that collects the pulsed laser beam oscillated by the oscillator, and applies the pulsed laser beam to the workpiece held on the chuck table. A repetition frequency of the pulsed laser beam oscillated by the oscillator is set to at least a value determined by multiplying a thermal conductivity λ[W/(m·K)] of the workpiece by a coefficient β[MHz·m·K/W].

It is preferable that the coefficient is β=0.2. Further, it is preferable that the oscillator includes: a packet setting unit that sets a packet having a group of arbitrary number of pulsed laser beams; a quasi-repetition frequency setting unit that sets a quasi-repetition frequency by thinning out a pulsed laser beam between the packet and an adjacent packet thereof; and a power amplifying unit that amplifies power of a pulsed laser beam. It is preferable that heating continuation of the workpiece is adjusted by the packet.

According to the present disclosure, a laser processing method to solve the above problem is provided. That is, a laser processing method for a workpiece, including: a preparing step of preparing a laser beam processing apparatus which includes a chuck table that holds the workpiece, a laser beam applying unit that applies a pulsed laser beam to the workpiece held on the chuck table, and a feeding unit that relatively feeds the chuck table and the laser beam applying unit for processing; a holding step of holding the workpiece on the chuck table; and a laser beam applying step of applying a pulsed laser beam to the workpiece held on the chuck table for processing, is provided. In the laser beam applying step, a repetition frequency of an oscillator that oscillates a pulsed laser beam is set at least to a value determined by multiplying a thermal conductivity λ[W/(m·K)] of the workpiece by a coefficient β[MHz·m·K/W].

The laser processing apparatus of the present disclosure is a laser processing apparatus including: a chuck table that holds a workpiece; a laser beam applying unit that applies a pulsed laser beam to the workpiece held on the chuck table; and a feeding unit that relatively feeds the chuck table and the laser beam applying unit for processing. The laser beam applying unit includes: an oscillator that oscillates a pulsed laser beam; and a condenser that collects a pulsed laser beam oscillated by the oscillator, and applies the pulsed laser beam to the workpiece held on the chuck table. A repetition frequency of the pulsed laser beam oscillated by the oscillator is set to at least a value determined by multiplying a thermal conductivity λ[W/(m·K)] of the workpiece by a coefficient β[MHz·m·K/W]. Therefore a desired processing result can be obtained for various workpieces without damaging the device during laser processing.

The laser processing method of the present disclosure includes: a preparing step of preparing a laser beam processing apparatus which includes a chunk table that holds a workpiece, a laser beam applying unit that applies a pulsed laser beam to the workpiece held on the chuck table, and a feeding unit that relatively feeds the chuck table and the laser beam applying unit for processing; a holding step of holding the workpiece on the chuck table; and a laser beam applying step of applying a pulsed laser beam to the workpiece held on the chuck table for processing. In the laser beam applying step, a repetition frequency of an oscillator that oscillates a pulsed laser beam is set to at least a value determined by multiplying a thermal conductivity λ[W/(m·K)] of the workpiece by a coefficient β[MHz·m·K/W]. Therefore a desired processing result can be obtained for various workpieces without damaging the device during laser processing.

### BRIEF DESCRIPTION OF THE DRAWINGS

FIG. 1 is a perspective view of a laser processing apparatus according to the present disclosure;

FIG. 2 is a schematic diagram of the laser beam applying unit indicated in FIG. 1;

FIG. 3 is a block diagram depicting a first configuration of the oscillator indicated in FIG. 2; and

FIG. 4A is a block diagram depicting a second configuration of the oscillator indicated in FIG. 2, and FIG. 4B is a schematic diagram of a pulsed laser beam oscillated by the oscillator indicated in FIG. 4A.

### DETAILED DESCRIPTION

Preferred embodiments of a laser processing apparatus according to the present disclosure will be described first with reference to the drawings.

### Laser Processing Apparatus 2

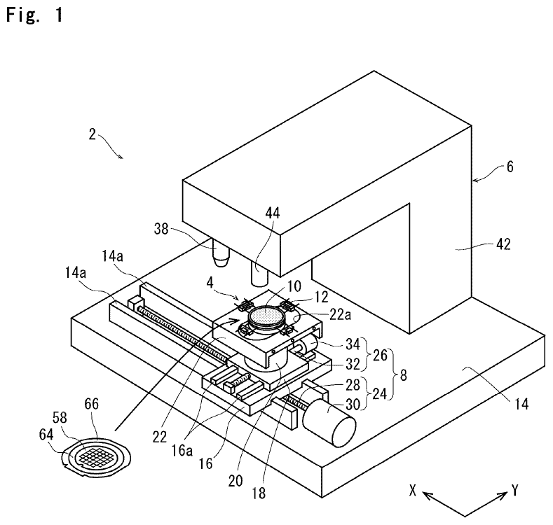

As illustrated in FIG. 1, a laser processing apparatus 2 includes a chuck table 4 that holds a workpiece, a laser beam applying unit 6 that applies a pulsed laser beam to the workpiece held on the chuck table 4, and a feeding unit 8 that relatively feeds the chuck table 4 and the laser beam applying unit 6 for processing.

### Chuck Table 4 of Laser Processing Apparatus 2

A circular suction chuck 10 is disposed on an upper end of the chuck table 4. The suction chuck 10 is formed of a porous member, such as porous ceramic. The suction chuck 10 is connected to a suction pump (not illustrated). On the chuck table 4, a suction force is generated on the upper surface of the suction chuck 10 using the suction pump, so that a workpiece placed on the upper surface of the suction chuck 10 can be held by suction. A plurality of clamps 12 are disposed on a periphery of the chuck table 4 with intervals in a circumferential direction.

The chuck table 4 is configured to be freely movable in the X axis direction indicated by the arrow X in FIG. 1, and in the Y axis direction (direction orthogonal to the X axis direction) indicated by the arrow Y in FIG. 1. The laser processing apparatus 2 of the present embodiment includes an X axis movable plate 16, which is mounted on the upper surface of a base 14 to be freely movable in the X axis direction, a Y axis movable plate 18, which is mounted in the upper surface of the X axis movable plate 16 to be freely movable in the Y axis direction, a support 20 which is fixed to the upper surface of the Y axis movable plate 18; and a cover plate 22 which is fixed to the upper end of the support 20. On the cover plate 22, a long hole 22a, which extends in the Y axis direction, is formed. The chuck table 4 is mounted on the upper end of the support 20 via the long hole 22a of the cover plate 22. Therefore the chuck table 4 is freely movable in the X axis direction and the Y axis direction via the X axis movable plate 16 and the Y axis movable plate 18. The chuck table 4 is rotatable by a motor (not illustrated) included in the support 20, around the shaft center in the vertical direction. The XY plane specified by the X axis direction and the Y axis direction is virtually horizontal.

### Feeding unit 8 of Laser Processing Apparatus 2

The feeding unit 8 will be described first before describing the laser beam applying unit 6. The feeding unit 8 of the present embodiment includes an X axis feeding unit 24 that feeds the chuck table 4 in the X axis direction for processing, and a Y axis feeding unit 26 that feeds the chuck table 4 in the Y axis direction for indexing.

The X axis feeding unit 24 includes a ball screw 28 that is connected to the X axis movable plate 16 and extends in the X axis direction, and a motor 30 that rotates the ball screw 28. The X axis feeding unit 24 converts the rotary motion of the motor 30 into linear motion using the ball screw 28, and transfers the linear motion to the X axis movable plate 16, so that the X axis movable plate 16 is moved in the X axis direction along a guide rail 14a on the base 14. Thereby the chuck table 4 is fed in the X axis direction for processing.

The Y axis feeding unit 26 includes a ball screw 32 that is connected to the Y axis movable plate 18 and extends in the Y axis direction, and a motor 34 that rotates the ball screw 32. The Y axis feeding unit 26 converts the rotary motion of the motor 34 into linear motion using the ball screw 32, and transfers the linear motion to the Y axis movable plate 18, so that the Y axis movable plate 18 is moved in the Y axis direction along a guide rail 16a on the X axis movable plate 16. Thereby the chuck table 4 is fed in the Y axis direction for indexing.

### Laser Beam Applying Unit 6 of Laser Processing Apparatus 2

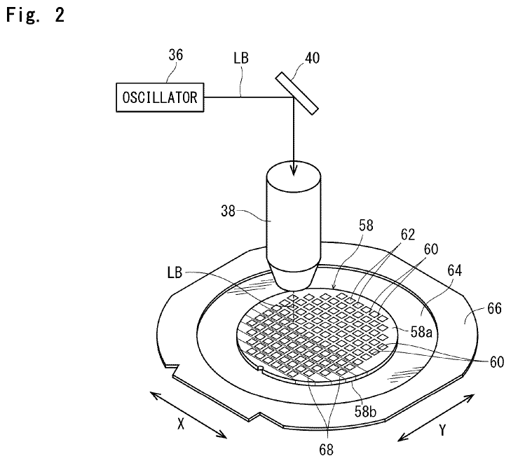

As illustrated in FIG. 2, the laser beam applying unit 6 includes an oscillator 36 that oscillates a pulsed laser beam LB, and a condenser 38 that condenses the pulsed laser beam LB oscillated by the oscillator 36, and applies the condensed pulsed laser beam LB to a workpiece held on the chuck table 4. A mirror 40, which guides the pulsed laser beam LB oscillated by the oscillator 36 to the condenser 38, is disposed between the oscillator 36 and the condenser 38. The laser beam applying unit 6 also includes a housing 42 that extends upward from the upper surface of the base 14, then extends substantially in the horizontal direction, as illustrated in FIG. 1. The oscillator 36 is housed inside the housing 42, and the condenser 38 is mounted on the lower surface of the front end of the housing 42. Further, an imaging unit 44, to image a workpiece held on the chuck table 4, is also disposed on the lower surface of the front end of the housing 42.

A repetition frequency F of the pulsed laser beam LB oscillated by the oscillator 36 is set to at least a value determined by multiplying a thermal conductivity λ[W/(m·K)] of a workpiece by a coefficient β[MHz·m·K/W] (see the following Expression 1).

$$F \geq λ \cdot β \qquad Expression 1$$

Here the coefficient β is preferably 0.2 [MHz·m·K/W]. For example, in a case where a workpiece is quartz, the thermal conductivity of quartz is 1.4 [W/(m·K)], hence the value λ·β, determined by multiplying the thermal conductivity λ by the coefficient β, becomes as follows.

$$λβ = 1.4 \times 0.2 = 0.28$$

Therefore in a case where a workpiece is quartz, the repetition frequency F of the pulsed laser beam LB, oscillated by the oscillator 36, is set to at least a value 0.28 MHz.

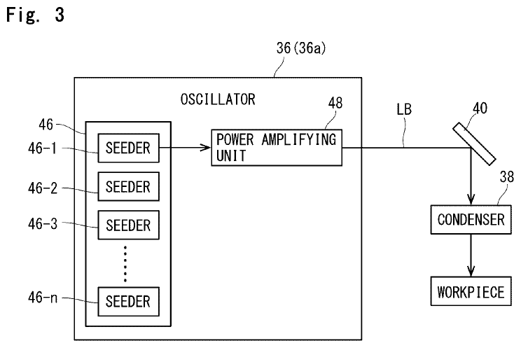

Oscillator 36a of Laser Beam Applying Unit 6: Configuration in FIG. 3

The oscillator 36 that oscillates the pulsed laser beam LB having the above mentioned repetition frequency F is configured as indicated in FIG. 3, for example. An oscillator 36a in FIG. 3 includes a plurality of seeders 46-1, 46-2, 46-3, . . . , 46-n (these may collectively be called “seeders 46” hereafter), and a power amplifying unit 48 that amplifies power of a pulsed laser beam LB oscillated by any one of the plurality of seeders 46.

### Seeders 46 of Oscillator 36a

The plurality of seeders 46 are configured to oscillate pulsed laser beams LB having mutually different repetition frequencies. The repetition frequencies of the plurality of seeders 46 can be set stepwise in a 10 MHz to 1 GHz range, for example. Specific examples of the repetition frequencies of the plurality of seeders 46 follow.

| | | |
|---|---|---|
| Seeder 46-1: repetition frequency | 10 | MHz |
| Seeder 46-2: repetition frequency | 30 | MHz |
| Seeder 46-3: repetition frequency | 50 | MHz |
| . . . | | |
| Seeder 46-n: repetition frequency | 1 | GHz |

The repetition frequencies of the plurality of seeders 46 are not limited to the above values. A number of seeders 46 may be an arbitrary number.

In a case where the laser beam applying unit 6 includes the oscillator 36a indicated in FIG. 3, a seeder having a repetition frequency F that is at least a value determined by multiplying a thermal conductivity λ[W/(m·K)] of a workpiece by a coefficient β[MHz·m·K/W] is selected from the plurality of seeders 46. The pulsed laser beam LB oscillated by the selected seeder is adjusted to an appropriate power by the power amplifying unit 48, is then reflected by the mirror 40 and guided to the condenser 38, and is applied to the workpiece.

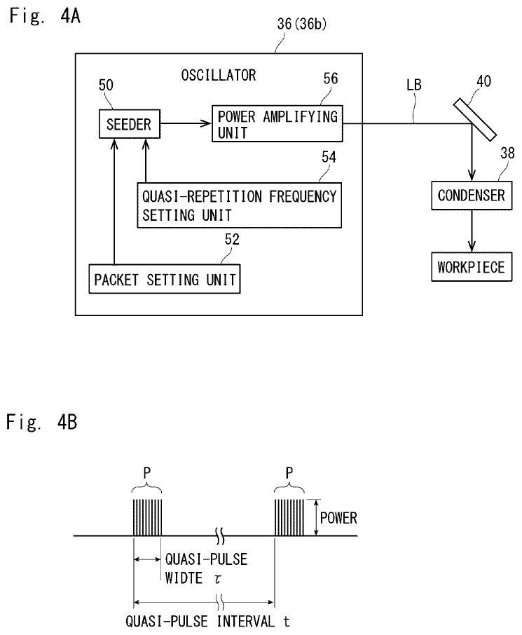

Oscillator 36b of Laser Beam Applying Unit 6: Configuration in FIGS. 4A and 4B

The oscillator 36 that oscillates the pulsed laser beam LB having the above mentioned repetition frequency F may have a configuration indicated in FIG. 4A. An oscillator 36b indicated in FIG. 4A includes a seeder 50, a packet setting unit 52, a quasi-repetition frequency setting unit 54, and a power amplifying unit 56.

### Seeder 50 of Oscillator 36b

A seeder 50 is configured to oscillate a pulsed laser beam LB having a relatively high repetition frequency. The repetition frequency of the pulsed laser beam LB oscillated by the seeder 50 may be 10 GHZ, for example.

### Packet Setting Unit 52 of Oscillator 36b

The packet setting unit 52 sets a packet P having a group of an arbitrary number of pulsed laser beams LB. For example, as illustrated in FIG. 4B, the packet setting unit 52 sets a packet P having a group of 10 pulsed laser beams LB (10 pulses) oscillated by the seeder 50 (one packet: 10 pulses). By adjusting a number of pulses included in one packet P, the packet setting unit 52 can adjust a quasi-pulse width τ (a pulse width in a case of regarding one packet P as one pulse), which is a time width of one packet P.

### Quasi-Repetition Frequency Setting Unit 54 of Oscillator 36b

The quasi-repetition frequency setting unit 54 sets a quasi-repetition frequency Fs by thinning the pulsed laser beams LB between a packet P and a packet adjacent to the packet P. The quasi-repetition frequency Fs is a repetition frequency of the packet P, and is a reciprocal of the quasi-pulse interval t (Fs=1/t). Here the quasi-pulse interval t is a time interval of the packets P.

### Power Amplifying Unit 56 of Oscillator 36b

The power amplifying unit 56 amplifies the power of the pulsed laser beam LB. Specifically, the power amplifying unit 56 amplifies the power of the pulsed laser beam LB, for which number of pulses included in one packet P is set by the packet setting unit 52, and the quasi-repetition frequency Fs (repetition frequency of packet P) is set by the quasi-repetition frequency setting unit 54.

In the case where the laser beam applying unit 6 includes the oscillator 36b indicated in FIG. 4A, the quasi-repetition frequency Fs (repetition frequency of pocket P) is set to at least a value determined by multiplying a thermal conductivity λ[W/(m·K)] of a workpiece by a coefficient β[MHz·m·K/W]. The pulsed laser beam LB of which quasi-repetition frequency Fs is set to an appropriate value is adjusted to an appropriate power of the power amplifying unit 56, is then reflected by the mirror 40 and guided to the condenser 38, and is applied to the workpiece.

In the oscillator 36b indicated in FIG. 4A, by adjusting the quasi-pulse width t of the packet P, the heating continuation of the workpiece (heating continuation of the workpiece by applying the pulsed laser beam LB) can be adjusted.

### Workpiece

In FIG. 2, a disk-shaped wafer 58, which is a workpiece to be processed by the laser processing apparatus 2, is also illustrated. The wafer 58 is formed of such material as quartz, sapphire, SiC or diamond. The front surface 58a of the wafer 58 is divided into a plurality of rectangular regions by division lines 60 in a lattice. On each of the rectangular regions, a device 62, such as an IC and LSI, is formed. The wafer 58 is supported by an annular frame 66 via an adhesive tape 64. In the present embodiment, a rear surface 58b of the wafer 58 is adhered to the adhesive tape 64, but the front surface 58a of the wafer 58 may be adhered to the adhesive tape 64.

### Processing Method

Preferred embodiments of the laser processing method according to the present disclosure will be described next.

### Preparing Step

In the present embodiment, a preparing step is performed first, where a laser processing apparatus, which includes a chuck table that holds a workpiece, a laser beam applying unit that applies a pulsed laser beam to the workpiece held on the chuck table, and a feeding unit that relatively feeds the chuck table and the laser beam applying unit for processing, is prepared. The laser processing apparatus prepared in the preparation step may be the laser processing apparatus 2 described above. In the present description, a case of processing a wafer 58 (workpiece) using the above mentioned laser processing apparatus 2 will be described.

### Holding Step

After performing the preparing step, a holding step is performed, where the wafer 58 (workpiece) is held on the chuck table 4. In the holding step, the wafer 58 is placed on the upper surface of the chuck table 4 such that the adhesive tape 64 side faces downward and the wafer 58 side face upward. Then a suction force is generated in the suction chuck 10 using the suction pump, so that the wafer 58 is held on the upper surface of the chuck table 4 by suction. Then the annular frame 66 is fixed by a plurality of clamps 12.

### Laser Beam Applying Step

After performing the holding step, a laser beam applying step is performed, where a pulsed laser beam LB is applied to the wafer 58 held on the chuck table 4 for processing.

In the laser beam applying step, the focusing point of the pulsed laser beam LB is positioned on the division line 60 of the wafer 58. Here the imaging unit 44 captures an image of the wafer 58, and based on the image of the wafer 58 captured by the imaging unit 44, the chuck table 4 is appropriately rotated, so as to align the division line 60 of the wafer 58 in the X axis direction. Then the focusing point of the pulsed laser beam LB is positioned on the division line 60 which is aligned in the X axis direction. The position of the focusing point in the vertical direction can be freely set.

Once the focusing point of the pulsed laser beam LB is positioned at a predetermined position, the pulsed laser beam LB is applied to the wafer 58 along the division line 60, so as to perform the laser processing along the division line 60. For example, while feeding the chuck table 4 in the X axis direction for processing, a pulsed laser beam LB, having a wavelength which is transmissive to the wafer 58, is applied from the condenser 38 to the wafer 58, whereby a start point of division (modified layer or seed tunnel) is formed inside the division line 60. The seed tunnel is constituted of a pore penetrating the wafer 58 from the front surface 58a to the rear surface 58b, and an amorphous substance surrounding the pore. In the laser beam applying step, while feeding the chuck table 4 in the X axis direction for processing, a pulsed laser beam LB, having a wavelength which is absorptive to the wafer 58, may be applied from the condenser 38 to the wafer 58 to perform ablation processing along the division line 60, so as to form a start point of division.

While the chuck table 4 is indexed-fed in the Y axis direction using the Y axis feeding unit 26 for the amount of the interval of the division lines 60 in the Y axis direction, the pulsed laser beam LB is repeatedly applied so that all the division lines 60 aligned in the X axis direction are laser-processed. Further, the chuck table 4 is rotated 90°, then applying the pulsed laser beam LB and the index-feeding are alternately repeated, so that all the division lines 60 orthogonal to the already processed division lines 60 are laser-processed.

In the laser beam applying step, it is critical to set the repetition frequency F of the oscillator 36 to oscillate the pulsed laser beam LB to at least a value determined by multiplying a thermal conductivity λ[W/(m·K)] of the wafer 58 by a coefficient β[MHz·m·K/W]. However in the case where the laser beam applying unit 6 includes the oscillator 36b indicated in FIG. 4A, the quasi-repetition frequency Fs, which is a repetition frequency of the packet P, is set to at least a value determined by multiplying a thermal conductivity λ[W/(m·K)] of the wafer 58 by a coefficient β[MHz·m·K/W]. Thereby even if the start point of the division is formed along the division lines 60, cracking does not extend along the crystal structure of the wafer 58, and the device 62 is not damaged during the laser processing.

Furthermore, in the laser beam applying step, the repetition frequency F or the quasi-repetition frequency Fs is set to at least a value determined by multiplying a thermal conductivity λ[W/(m·K)] of the wafer 58 by a coefficient β[MHz·m·K/W], hence effective heating continuation of the wafer 58 is implemented. Therefore a predetermined processing result can be quickly obtained without trying processing too many times while adjusting such processing conditions as output, feeding speed and focusing point position of the pulsed laser beam LB. In the case where the laser beam applying unit 6 includes the oscillator 36b indicated in FIG. 4A, the heating continuation of the wafer 58 can be further adjusted by adjusting the quasi-pulse width τ of the packet P, hence an even more effective processing result can be obtained.

As described above, in the present embodiment, the repetition frequency F of the oscillator 36, that oscillates the pulsed laser beam LB, is set to at least a value determined by multiplying a thermal conductivity λ[W/(m·K)] of the wafer 58 by a coefficient β[MHz·m·K/W], hence the device 62 is not damaged during laser processing, and a predetermined processing result can be obtained for various workpieces.

### Experiments

To determine a coefficient β with which optimum laser processing is performed by applying the pulsed laser beam to a wafer, the present inventor performed experiments by applying the pulsed laser beam to wafers formed of various materials, while changing the coefficient β. The conditions of the pulsed laser beam and the wafers which were processed by laser follow.

### Conditions of Pulsed Laser Beam

Wavelength: 1064 nm
Average output: 1 W

### Wafer

| Material | Thermal conductivity λ[W/(m · K)] | Thickness [μm] |
|---|---|---|
| Quartz | 1.4 | 700 |
| Sapphire | 42 | 700 |
| SiC | 490 | 700 |
| Diamond | 2000 | 700 |

The result of performing the laser processing on each of the above mentioned wafers is as follows. “OK” in the following determination indicates that the start point of division was formed along the division line, without cracking extending along the crystal structure of the wafer. Whereas “NG” in the following determination indicates that the start point of division was not formed appropriately along the division line, because of the cracking extending along the crystal structure of the wafer.

Experiment Result 1: Quarts Wafer, λ=1.4 Coefficient λ[W/(m·K)] Repetition frequency [MHz]

Determination

| | | |
|---|---|---|
| 1.0 | 1.4 | OK |
| 0.5 | 0.7 | OK |
| 0.3 | 0.42 | OK |
| 0.2 | 0.28 | OK |
| 0.15 | 0.21 | NG |
| 0.1 | 0.14 | NG |

Experiment Result 2: Sapphire Wafer, λ=42 Coefficient λ[W/(m·K)] Repetition frequency [MHz]

Determination

| | | |
|---|---|---|
| 1.0 | 42 | OK |
| 0.5 | 21 | OK |
| 0.3 | 12.6 | OK |
| 0.2 | 8.4 | OK |
| 0.15 | 6.3 | NG |
| 0.1 | 4.2 | NG |

Experiment Result 3: Sic Wafer, λ=490 Coefficient λ[W/(m·K)] Repetition frequency [MHz]

Determination

| | | |
|---|---|---|
| 1.0 | 490 | OK |
| 0.5 | 245 | OK |
| 0.3 | 147 | OK |
| 0.2 | 98 | OK |
| 0.15 | 73.5 | NG |
| 0.1 | 49 | NG |

Experiment Result 4: Diamond Wafer, λ=2000 Coefficient λ[W/(m·K)] Repetition frequency [MHz]

Determination

| | | |
|---|---|---|
| 1.0 | 2000 | OK |
| 0.5 | 1000 | OK |
| 0.3 | 600 | OK |
| 0.2 | 400 | OK |
| 0.15 | 300 | NG |
| 0.1 | 200 | NG |

As the above experiment results 1 to 4 indicates, if the coefficient β is at least 0.2, good laser processing can be performed regardless whether the wafer material is quartz, sapphire, SiC or diamond. The present inventor also confirmed that the same tendency exists in a single crystal wafer formed of lithium tantalate (LT), lithium niobate (LN), gallium nitride (GaN) or the like, although those experiment results are omitted here.

### REFERENCE SIGNS LIST

2 Laser processing apparatus
4 Chuck table
6 Laser beam applying unit
8 Feeding unit
36 Oscillator
38 Condenser
52 Packet setting unit
54 Quasi-repetition frequency setting unit
56 Power amplifying unit

What is claimed is:

1. A laser processing apparatus, comprising:
a chuck table configured to hold a workpiece; a laser beam applying unit configured to apply a pulsed laser beam to the workpiece held on the chuck table; and a feeding unit configured to relatively feed the chuck table and the laser beam applying unit for processing, wherein
the laser beam applying unit includes: an oscillator configured to oscillate a pulsed laser beam; and a condenser configured to collect the pulsed laser beam oscillated by the oscillator and apply the pulsed laser beam to the workpiece held on the chuck table, wherein
a repetition frequency of the pulsed laser beam oscillated by the oscillator is set to at least a value determined by multiplying a thermal conductivity λ[W/(m·K)] of the workpiece by a coefficient β[MHz·m·K/W].

2. The laser processing apparatus of claim 1, wherein the coefficient is β=0.2.

3. The laser processing apparatus of claim 1, wherein
the oscillator includes: a packet setting unit configured to set a packet having a group of an arbitrary number of pulsed laser beams; a quasi-repetition frequency setting unit configured to set a quasi-repetition frequency by thinning the pulsed laser beams between the packet and an adjacent packet thereby; and a power amplifying unit configured to amplify power of a pulsed laser beam, wherein
heating continuation of the workpiece is adjusted by the packet.

4. A laser processing method for a workpiece, comprising:
a preparing step of preparing a laser processing apparatus which includes a chuck table configured to hold the workpiece, a laser beam applying unit configured to apply a pulsed laser beam to the workpiece held on the chuck table, and a feeding unit configured to relatively feed the chuck table and the laser beam applying unit for processing;
a holding step of holding the workpiece on the chuck table; and
a laser beam applying step of applying a pulsed laser beam to the workpiece held on the chuck table for processing, wherein
in the laser beam applying step, a repetition frequency of an oscillator configured to oscillate a pulsed laser beam is set to at least a value determined by multiplying a thermal conductivity λ[W/(m·K)] of the workpiece by a coefficient β[MHz·m·K/W].
